(19) United States
(12) Patent Application Publication
(10) Pub. No.: US 2015/0112780 A1
(43) Pub. Date: Apr. 23, 2015

(54) METHOD AND SYSTEM FOR PROCESSING OF A REAL-TIME REBATE AT TRANSACTION AUTHORIZATION

(71) Applicant: MasterCard International Incorporated, Purchase, NY (US)

(72) Inventors: Christopher Andrew GUINEY, Fenton, MO (US); Jensen James E. Pastrana, O'Fallon, MO (US)

(73) Assignee: MasterCard International Incorporated, Purchase, NY (US)

(21) Appl. No.: 14/058,548

(22) Filed: Oct. 21, 2013

(51) Int. Cl. G06Q 30/02

(52) U.S. Cl. CPC G06Q 30/0234; G06Q 30/0215
USPC 705/14.17

(57) ABSTRACT

A method for initiating a rebate for a payment transaction funded using a reward account includes: storing account data entries, each entry including an account identifier and reward balance; receiving an authorization request for a transaction involving a merchant, the request including payment information and a transaction amount; calculating a transaction reward value based on the transaction amount and a conversion rule; identifying a reduction amount, wherein the amount is a lesser of the transaction reward value and the reward balance included in a data entry where the account identifier corresponds to the payment information; updating the reward balance included in the data entry based on the identified reduction amount; calculating a rebate amount based on the transaction reward value and reduction amount, and the conversion rule; and transmitting a rebate request for the rebate amount from an account of the merchant to an account corresponding to the payment information.

### FIELD

The present disclosure relates to the initiating of a rebate for a payment transaction funded using a reward account, specifically the automatic initiating of a rebate on a reward account following the processing of a payment transaction based on a reward balance.

### BACKGROUND

In an effort to increase use, many payment card issuers offer rewards to cardholders for use of their payment card. Rewards may come in a variety of forms, such as reward points that may be redeemed for cash or products, cash back, airline miles, reward points with a specific vendor (e.g., a travel service, hotel, merchant, retailer, etc.), a reward level based on activity where each level may have corresponding benefits, and more. However, these traditional reward schemes often require a significant amount of actions to be taken by the cardholder in order to receive the benefit. In addition, the cardholder is typically unable to take advantage of rewards directly at a point-of-sale, instead being required to redeem a reward, receive the reward, and then utilize the reward at a point-of-sale.

In order to streamline the redemption of reward benefits at a point-of-sale, some systems and methods have been developed to enable the redemption of reward points or other benefits upon the use of a special payment card. For example, the system described in U.S. Patent Publication No. 2010/0057553, filed on Sep. 4, 2009, which is herein incorporated by reference in its entirety, uses a payment card that is authorized only against the use of a reward balance of points. However, as the card is only authorized against the use of points, the card is unavailable to be used for traditional payment transactions, which may frustrate or confuse consumers, particularly if a consumer does not wish to carry around multiple payment cards. Another system has been developed where a physical switch is included on a payment card that may be toggled by the cardholder to switch between use as a traditional payment card and payment via a reward balance. However, this again may frustrate consumers who may forget to switch between use types. Furthermore, the difference in the two payment methods may result in the inability for a cardholder to pay using both credit and a reward balance.

Thus, there is a need for a technical solution to provide a payment card to a consumer that may be used for both traditional payment transactions and transactions against a reward balance, without requiring intervention by the cardholder and also allowing for partial payment via the reward balance.

### SUMMARY

The present disclosure provides a description of systems and methods for initiating of a rebate for a payment transaction funded using a reward account.

A method for initiating a rebate for a payment transaction funded using a reward account includes: storing, in a database, a plurality of account data entries, wherein each account data entry includes data related to a consumer reward account including at least an account identifier and a reward balance; receiving, by a receiving device, an authorization request for a payment transaction involving a merchant, wherein the authorization request includes at least payment information and a transaction amount; calculating, by a processing device, a transaction reward value based on at least the transaction amount and at least one conversion rule; identifying, by the processing device, a reduction amount, wherein the reduction amount is a lesser of the transaction reward value and the reward balance included in a specific account data entry in the database where the included account identifier corresponds to the payment information; updating, in the database, the reward balance included in the specific account data entry based on the identified reduction amount; calculating, by the processing device, a rebate amount based on the transaction reward value and the identified reduction amount, and the at least one conversion rule; and transmitting, by a transmitting device, a rebate request for the calculated rebate amount from a payment account associated with the merchant to a payment account corresponding to the payment information.

A system for initiating a rebate for a payment transaction funded using a reward account includes a database, a receiving device, a processing device, and a transmitting device. The database is configured to store a plurality of account data entries, wherein each account data entry includes data related to a consumer reward account including at least an account identifier and a reward balance. The receiving device is configured to receive an authorization request for a payment transaction involving a merchant, wherein the authorization request includes at least payment information and a transaction amount. The processing device is configured to: calculate a transaction reward value based on at least the transaction amount and at least one conversion rule; identify a reduction amount, wherein the reduction amount is a lesser of the transaction reward value and the reward balance included in a specific account data entry in the database where the included account identifier corresponds to the payment information; update, in the database, the reward balance included in the specific account data entry based on the identified reduction amount; and calculate a rebate amount based on the transaction reward value and the identified reduction amount, and the at least one conversion rule. The transmitting device is configured to transmit a rebate request for the calculated rebate amount from a payment account associated with the merchant to a payment account corresponding to the payment information.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for initiating a rebate for a payment transaction funded using a reward account in accordance with exemplary embodiments.

FIG. 2 is a block diagram illustrating the processing server of FIG. 1 for the initiating of the rebate for the reward account-funded payment transaction in accordance with exemplary embodiments.

FIG. 3 is a flow diagram illustrating a process for the processing of a payment transaction funded using a reward account and the initiating and processing of a rebate for the reward account based on a reward balance in accordance with exemplary embodiments.

FIG. 4 is a flow diagram illustrating a process for the initiating of a rebate request by the processing server of FIG. 2 following a payment transaction funded using a reward account in accordance with exemplary embodiments.

FIG. 5 is a flow chart illustrating an exemplary method for initiating a rebate for a payment transaction funded using a reward account in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Reward Account—A payment account that, when used to fund a transaction, may earn rewards for the account holder. Rewards may be in the form of points, levels, cash back, miles, or other suitable frequency value as will be apparent to persons having skill in the relevant art. The amount of accrued rewards may be referred to as a rewards balance, such as the more rewards earned by an account holder may result in an increased (e.g., higher) rewards balance. As used herein, “points” may refer to rewards for a reward account generally and “point balance” may refer to the reward balance for a reward account generally.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Processing Rebate Requests for a Reward Account

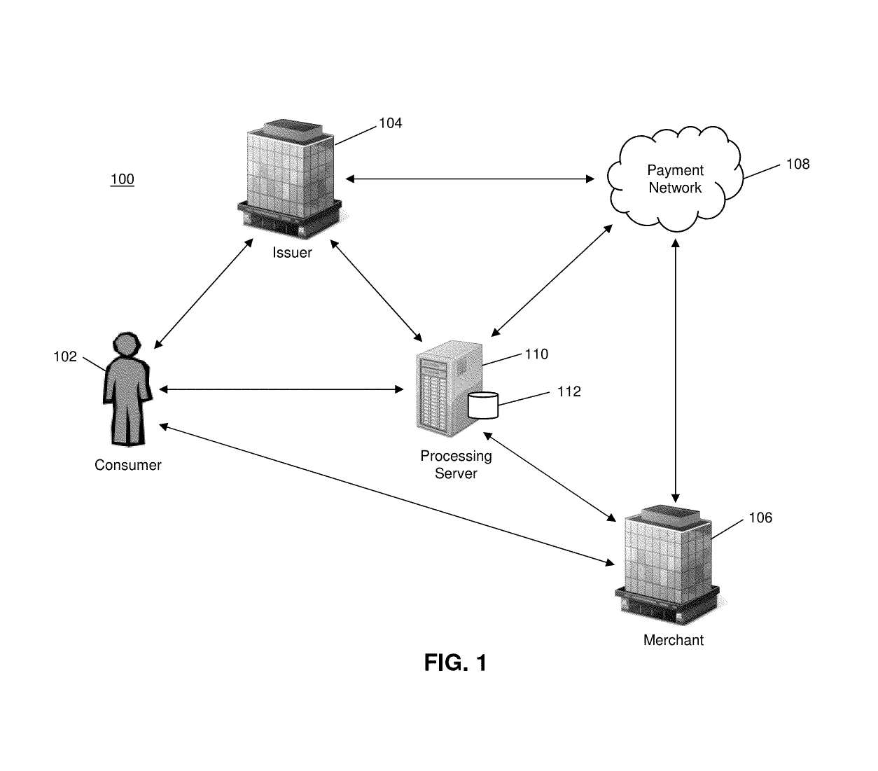

FIG. 1 illustrates a system 100 for the initiating and processing of a rebate for a payment transaction funded using a reward account.

The system may include a consumer 102. The consumer 102 may have a payment account with rewards enabled (e.g., a reward account) that is held by an issuer 104. In some instances, the issuer 104 may issue the consumer 102 a payment card associated with the reward account for use in funding payment transactions using the reward account. The consumer 102 may conduct a payment transaction with a merchant 106 to be funded by the reward account.

The merchant 106 (e.g., or an acquirer associated with the merchant 106) may submit an authorization request for the payment transaction funded by the reward account to a payment network 108. The payment network 108 may process the payment transaction using systems and methods that will be apparent to persons having skill in the relevant art. As part of, or following the processing, the payment network 108 may transmit a copy of the authorization request to a processing server 110. The authorization request transmitted to the processing server 110 may include at least payment information (e.g., indicating the reward account used to fund the payment transaction) and a transaction amount.

The processing server 110, discussed in more detail below, may be configured to initiate a rebate request for the reward account based on a reward balance. The processing server 110 may calculate a transaction reward value based on at least the transaction amount and at least one conversion rule. The conversion rule may be based on the merchant 106, the consumer 102, the issuer 104, transaction data for the payment transaction, or any other suitable value. The transaction reward value may be a representation of the value of rewards in the reward account required to fund the entire payment transaction via rewards. For example, a transaction reward value may be calculated to be 150 points for a $150 transaction.

The processing server 110 may also store, as discussed in more detail below, an account data entry corresponding to the consumer 102 in an account database 112. The account data entry may include at least a reward balance for the reward account used by the consumer 102 to fund the payment transaction. In some embodiments, the processing server 110 may be associated with the issuer 104 and/or may receive account information (e.g., the reward balance) from the issuer 104. The processing server 110 may identify a reduction amount for the account data entry, where the reduction amount is based on the lesser of the transaction reward value and the reward balance included in the account data entry. In such an instance, the reduction amount may account for scenarios where the reward balance exceeds the reward amount necessary to fund the payment transaction or where the reward balance does not exceed the reward amount and may only be used to partially fund the payment transaction.

The processing server 110 may then update the reward balance in the account data entry associated with the consumer 102 based on the reduction amount. The processing server 110 may also calculate a rebate amount for a rebate to be processed on the reward account for the payment transaction based on the reduction amount and the at least one conversion rule. The processing server 110 may then submit a rebate request to the payment network 108 for the rebate amount to be paid to the issuer 104 for the reward account based on the redeemed rewards. The payment network 108 may process the rebate using systems and methods that will be apparent to persons having skill in the relevant art.

In some embodiments, the processing server 110 may transmit a notification to the consumer 102 indicating the successful transmission of the rebate request to the payment network 108. The notification may be transmitted to the consumer 102 via short message service message, multimedia service message, e-mail, traditional mail, telephone, a website, an application program, or any other suitable method as will be apparent to persons having skill in the relevant art, which may be transmitted to the consumer 102 or a computing device associated with the consumer 102. In other embodiments, the processing server 110 may transmit another notification, in addition, or alternative to, the notification indicating successful transmission of the rebate request, indicating the successful processing of the rebate request. In some embodiments, the processing server 110 may also transmit a notification to the issuer 104, such as to provide an update as to the reward balance of the reward account based on the calculated updated reward balance.

In some instances, the processing server 110 may request permission from the consumer 102 to submit a rebate request for a payment transaction where the reward balance for the account data entry associated with the consumer 102 is less than the transaction reward value. In such an instance, the processing server 110 may submit a request to the consumer 102 (e.g., to a computing device associated with the consumer 102, such as a mobile computing device or a point-of-sale device where the payment transaction was conducted). The consumer 102 may respond to the request, which may be received by the processing server 110 and processed accordingly. The processing server 110 may submit a rebate request as discussed above if the consumer 102 wishes to use their reward balance, or may not submit any request if the consumer 102 does not wish to use their reward balance. In some embodiments, the processing server 110 may be configured to submit rebate requests based on partial use of a reward balance.

The systems and methods discussed herein may provide for a number of improvements over traditional systems and methods for enabling a consumer 102 to fund a payment transaction using rewards for a reward account. Because the processing server 110 may utilize a reward balance for funding of a payment transaction without requiring the consumer 102 to use a second payment card or to perform any actions prior to conducting the transaction, the processing server 110 may provide for faster and more efficient funding of payment transaction via rewards. As a result, the system 100 may potentially be more acceptable by consumers, which may, in turn, result in a higher rate of use, which may provide benefits to both consumers 102 and issuers 104.

In addition, by processing the use of rewards as a rebate request, the payment transaction itself may be conducted traditionally without modification to existing payment systems. Furthermore, the rebate request may be transmitted as a clearing record following the payment transaction, which may result in very fast processing of the rebate request. In such an instance, the initial authorization request submitted to the payment network 108 from the merchant 106 may be submitted traditionally, without interruption or intervention by the processing server 110, which may result in the maintaining of traditional processing speeds, which, when combined with the speed of clearing of the rebate request, may result in the processing of a rebate for a payment transaction using rewards with unnoticeable delay to the consumer 102.

### Processing Device

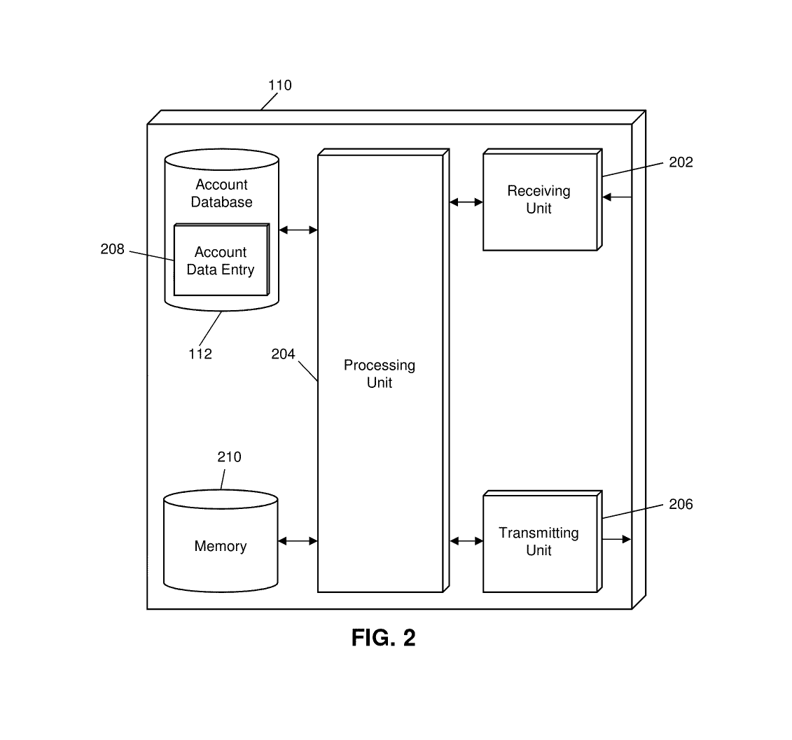

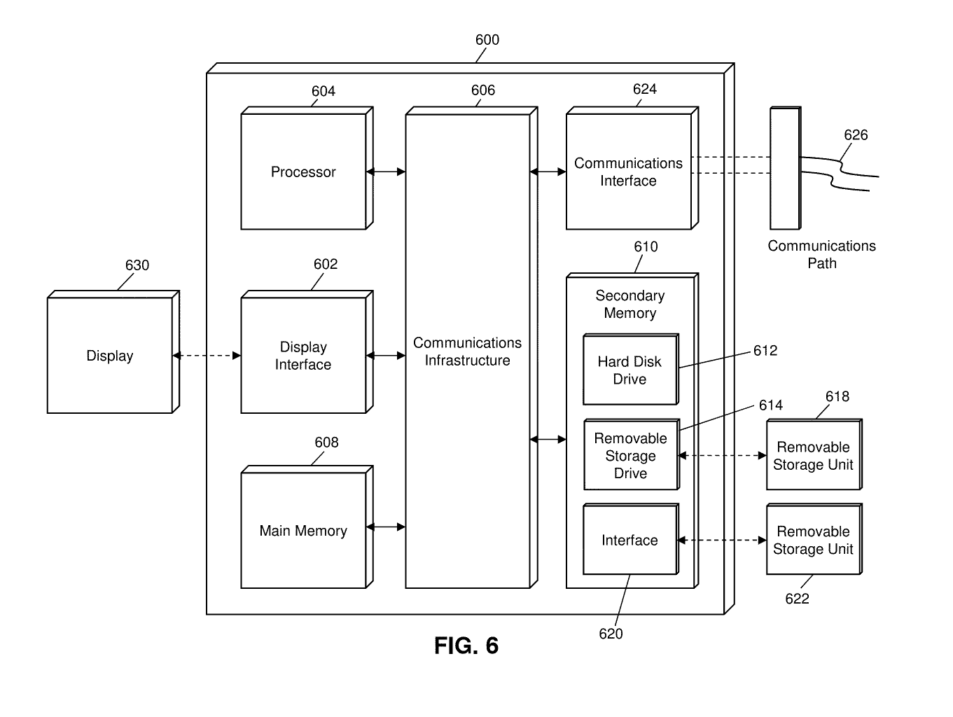

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of the processing server 110 suitable for performing the functions as discussed herein. For example, the computer system 600 illustrated in FIG. 6 and discussed in more detail below may be a suitable configuration of the processing server 110.

The processing server 110 may include a receiving unit 202. The receiving unit 202 may be configured to receive data over one or more networks via one or more network protocols. The receiving unit 202 may be configured to receive an authorization request from the payment network 108 corresponding to a payment transaction funded by a reward account, wherein the authorization request includes at least a transaction amount and payment information. The payment information may include an account identifier or other suitable information, as will be apparent to persons having skill in the relevant art, which may be used to identify the reward account used to fund the payment transaction.

The processing server 110 may further include a processing unit 204. The processing unit 204 may use the payment information to identify an account data entry 208 stored in the account database 112 associated with the reward account used to fund the payment transaction. Each account data entry 208 stored in the account database 112 may include data related to a consumer reward account including at least an account identifier and a reward balance. The account identifier may be a unique value used for identification, such as an identification number, a payment account number (e.g., of the associated reward account), username, e-mail address, phone number, etc. The reward balance may be a balance of the rewards earned by the consumer 102 for the associated reward account. In some instances, the reward balance may be received by the processing server 110 (e.g., via the receiving unit 202) from the issuer 104.

The processing unit 204 may be further configured to calculate a transaction reward value based on at least the transaction amount and one or more conversion rules, which may be stored in a memory 210. In some instances, the transaction reward value may be further based on at least one of: the consumer 102 (e.g., an account level for the consumer 102), the issuer 104 (e.g., issuer preferences, issuer category, etc.), the merchant 106 (e.g., merchant preferences, merchant category, merchant industry, etc.), transaction data included in the authorization request (e.g., product data, transaction time and/or date, geographic location, etc.), and more as will be apparent to persons having skill in the relevant art.

The processing unit 204 may also be configured to identify a reduction amount, which may be the lesser of the transaction reward value and the reward balance included in the identified account data entry 208. The processing unit 204 may then update the reward balance included in the identified account data entry 208 based on the current reward balance and the reduction amount, and may calculate a rebate amount based on the identified reduction amount and the at least one conversion rule. The processing unit 204 may generate a rebate request for the calculated rebate amount. In an example, the transaction amount may be $100 and the processing unit 204 may calculate a transaction reward value of 100 points. The identified account data entry 208 may include a reward balance of 75 points. The processing unit 204 may accordingly identify a reduction amount of 75 points, which may update the reward balance to be zero points, and may result in a calculated rebate amount of $75. The processing unit 204 may then generate a rebate request for $75 to the reward account.

The processing server 110 may also include a transmitting unit 206. The transmitting unit 206 may be configured to transmit data over one or more networks via one or more network protocols. The transmitting unit 206 may be configured to transmit the generated rebate request to the payment network 108 for processing. The transmitting unit 206 may also be configured to transmit notifications to the consumer 102 and/or the issuer 104 indicating the successful transmitting of the rebate request.

In some embodiments, the receiving unit 202 may receive a notification from the payment network 108 upon the successful processing of the rebate request. In such an embodiment, the transmitting unit 206 may be further configured to transmit a notification to the consumer 102 and/or the issuer 104 indicating the successful processing. In some instances, the notification may be transmitted in addition, or alternative to, a prior notification indicating successful transmission of the rebate request.

In embodiments where the reward balance for the identified account data entry 208 is less than the transaction reward value for the payment transaction, and if the processing server 110 requires consent of the consumer 102 for the partial funding of the payment transaction using rewards (e.g., based on previously received consumer preferences, which may be stored in the identified account data entry 208, for instance), the transmitting unit 206 may be configured to transmit a request for approval of the consumer 102 to proceed to the consumer 102. The request may be transmitted to the consumer 102 via any suitable method as will be apparent to persons having skill in the relevant art, such as via a computing device associated with the consumer 102 or a point-of-sale device used to conduct the payment transaction (e.g., as indicated in the authorization request). The receiving unit 202 may be configured to receive a response from the consumer 102 indicating to process the rebate request for the partial amount of the transaction amount or to withhold a rebate request. The processing unit 204 may identify the indication included in the response and may act accordingly as discussed above. In some embodiments, the account data entry 208 may indicate if the processing unit 204 is to generate a rebate request if the reward balance is less than the calculated transaction reward value.

### Processing of a Payment Transaction and Subsequent Processing of a Rebate Request

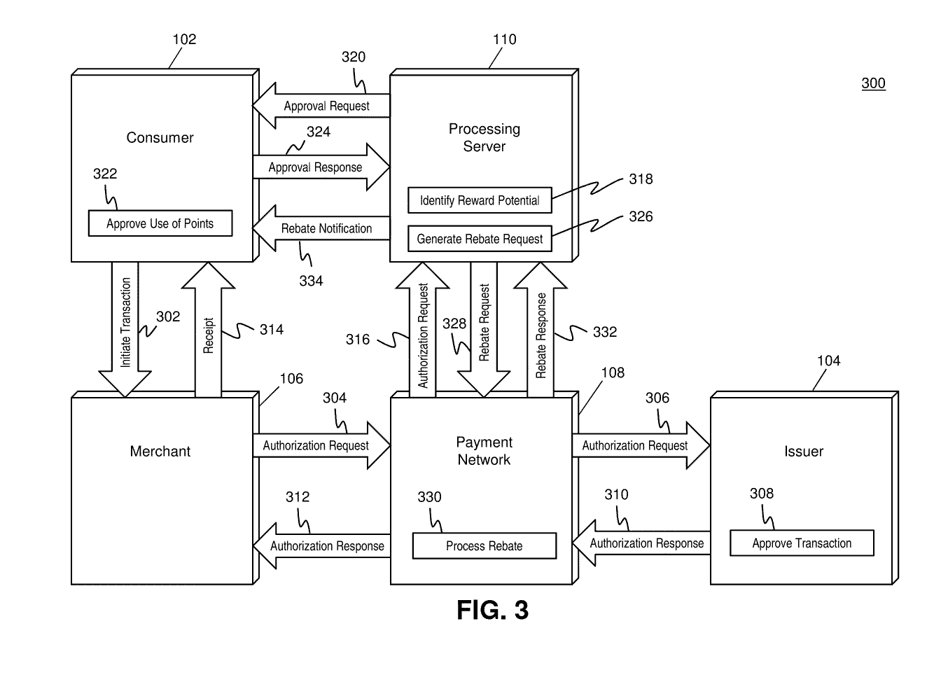

FIG. 3 illustrates a process for the processing of a payment transaction funded using a reward account and the subsequent processing of a rebate request using rewards earned on the reward account.

In step 302, the consumer 102 may initiate a payment transaction with the merchant 106 for the purchase of goods or services using a reward account. As part of the initiation of the payment transaction, the consumer 102 may provide the merchant 106 with an account number for the reward account (e.g., via a payment card or other suitable method). In step 304, the merchant 106 (e.g., or an acquirer associated with the merchant 106) may generate and submit an authorization request to the payment network 108 for processing. In step 306, the payment network 106 may forward the authorization request to the issuer 104 of the reward account. The issuer 108 may approve the payment transaction (e.g., based on adequate funding in the reward account), in step 308, and may transmit an authorization response indicating approval back to the payment network 108, in step 310.

In step 312, the payment network 108 may forward the authorization response to the merchant 106 indicating the approval of the payment transaction. It will be apparent to persons having skill in the relevant art that steps 304 through 312 are illustrative of the processing of a payment transaction using traditional systems and methods and that additional steps and/or additional entities may be included. In step 314, the merchant 106 may furnish a receipt and/or transacted for goods or services to the consumer 102.

In step 316, the payment network 108 may transmit a copy of the authorization request for the payment transaction, including at least payment information and a transaction amount, to the processing server 110. In step 318, the processing server 110 may identify an account data entry 208 associated with the reward account used to fund the payment transaction and may further identify the potential for the use of rewards to fund the payment transaction based on a reward balance included in the identified account data entry 208 and a transaction reward value calculated based on the transaction amount and at least one conversion rule. In instances where the consumer 102 may be required to approve the use of rewards to fully or partially fund the payment transaction, the processing server 110 may submit an approval request to the consumer 102, in step 320.

In step 322, the consumer 102 may approve the use of points via a computing device (e.g., a mobile computing device, a point-of-sale device at the merchant 106, etc.) or other suitable method. An approval response indicating the consumer's approval may be transmitted to the processing server 110, in step 324. In step 326, the processing server 110 may then generate a rebate request for a rebate amount based on the reduction amount and the at least one conversion rule. In step 328, the processing server 110 may transmit the rebate request to the payment network 108.

In step 330, the payment network 108 may process the rebate request using methods and systems that will be apparent to persons having skill in the relevant art. The rebate may be processed from an account associated with the merchant 106 to the reward account associated with the consumer 102. In step 332, the payment network 108 may transmit a rebate response indicating the successful processing of the rebate for the rebate amount to the reward account. In step 334, the processing server 110 may transmit a notification to the consumer 102 indicating the successful processing of the rebate. In some instances, the notification may further include an updated reward amount and other suitable information as will be apparent to persons having skill in the relevant art.

### Method for Generating and Initiating a Rebate Request

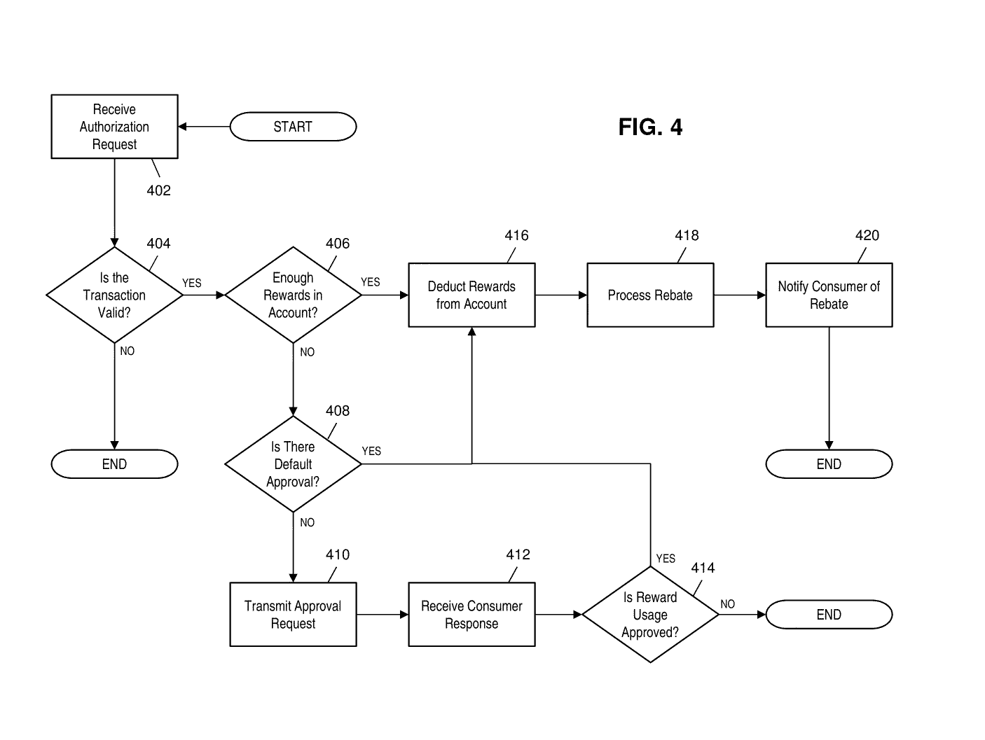

FIG. 4 illustrates a method for the generating and processing thereof of a rebate request for a rebate for a payment transaction funded using a reward account as executed via the processing server 110 of the system 100.

In step 402, the receiving unit 202 of the processing server 110 may receive an authorization request for a payment transaction funded using a reward account. The authorization request may include at least payment information and a transaction amount. In step 404, the processing unit 204 may determine if the payment transaction is a valid transaction for the full or partial funding of the payment transaction using rewards. Step 404 may include the identification of an account data entry 208 stored in the account database 112 using the payment information included in the authorization request. If a valid account data entry 208 is not identified, then the transaction may not be considered valid, and the process may be ended.

If a valid account data entry 208 is identified and the transaction may be fully or partially funded using rewards, then, in step 406, the processing unit 204 may determine if there is an adequate rewards balance in the account for the funding of the payment transaction. Step 406 may include the calculation of a transaction reward value based on the transaction amount for the payment transaction and one or more conversion rules, and identification if a reward balance included in the identified account data entry 208 meets or exceeds the calculated transaction reward value. If the reward balance is not adequate, then, in step 408, the processing unit 204 may determine if there is default approval from the consumer 102 associated with the reward account for partial funding of the payment transaction, such as based on data included in the identified account data entry 208.

If default approval is not provided by the consumer 102, then, in step 410, the transmitting unit 206 of the processing server 110 may transmit an approval request to the consumer 102. In some embodiments, the method of communication of the approval request may be included in the identified account data entry 208. In step 412, the receiving unit 202 may receive a response from the consumer 102 indicating the approval or denial of the usage of rewards to partially fund the payment transaction. In step 414, the processing unit 204 may identify in the consumer response if usage of rewards is approved. If usage is not approved, then the process may be completed.

If usage is approved by the consumer 102 in the consumer response, or if usage is approved by default by the consumer 102, or if there is an adequate reward balance for fully funding the payment transaction, then, in step 416, the processing unit 204 may deduct the corresponding reward amount from the reward balance in the identified account data entry 208. The processing unit 204 may then, in step 418, process the rebate for the payment transaction. Processing the rebate may calculating a rebate amount, which may be based on the transaction reward value, reward reduction amount, and at least one conversion rule, generating a rebate request for the calculated rebate amount, and transmitting thereof, by the transmitting unit 206, to the payment network 108 for processing. In step 420, the transmitting unit 206 may transmit a notification to the consumer 102 indicating the processing of the rebate. In some instances, the notification may include at least one of: the reduction amount, the rebate amount, and the updated reward balance.

### Method for Initiating a Rebate for a Payment Transaction Funded Using a Reward Account

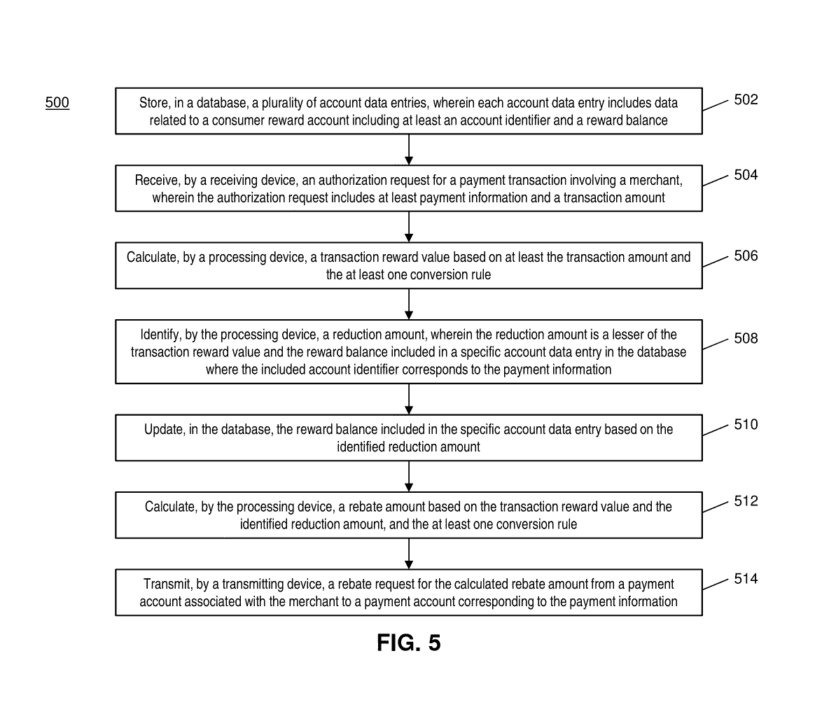

FIG. 5 illustrates a method 500 for the initiating of a rebate for a payment transaction funded using a reward account.

In step 502, a plurality of account data entries (e.g., the account data entries 208) may be stored in a database (e.g., the account database 112), wherein each account data entry 208 includes data related to a consumer reward account including at least an account identifier and a reward balance. In step 504, an authorization request for a payment transaction involving a merchant (e.g., the merchant 106) may be received, by a receiving device (e.g., the receiving unit 202), wherein the authorization request includes at least payment information and a transaction amount. In step 506, a transaction reward value may be calculated, by a processing device (e.g., the processing unit 204), based on at least the transaction amount and at least one conversion rule. In one embodiment, the at least one conversion rule is associated with at least one of: the merchant 106, the transaction amount, an account level, and a merchant category.

In step 508, a reduction amount may be identified, by the processing device 204, wherein the reduction amount is a lesser of the transaction reward value and the reward balance included in a specific account data entry 208 in the database 112 where the included account identifier corresponds to the payment information. In one embodiment, each account data entry 208 may further include an indication of whether the corresponding reward balance is to be used if the reward balance is less than the calculated transaction reward value. In some embodiments, the payment information included in the authorization request may include the account identifier included in the specific account data entry 208.

In step 510, the reward balance included in the specific account data entry 208 may be updated, in the database 112, based on the identified reduction amount. In step 512, a rebate amount may be calculated, by the processing device 204, based on the transaction reward value and the identified reduction amount, and the at least one conversion rule. In step 514, a rebate request for the calculated rebate amount from a payment account associated with the merchant 106 to a payment account corresponding to the payment information included in the authorization request may be transmitted, by a transmitting device (e.g., the transmitting unit 206). In some embodiments, the rebate request may be transmitted to a payment network (e.g., the payment network 108).

In one embodiment, the method 500 may further include: transmitting, by the transmitting device 206, a notification to a consumer (e.g., the consumer 102) associated with the specific account data entry 208 indicating successful transmission of the rebate request. In another embodiment, the method 500 may further include: receiving, by the receiving device 202, an indication of successful processing of a rebate in response to the transmitted rebate request; and transmitting, by the transmitting device 206, a notification to the consumer 102 associated with the specific account data entry indicating the successful processing of the rebate.

In some embodiments, the method 500 may further include receiving, by the receiving device 202, an indication to proceed with transmitting the rebate request prior to the transmitting of the rebate request when the reward balance is less than the transaction reward value. In a further embodiment, the indication to proceed may be received in response to transmitting, by the transmitting device 206, a request to proceed to a computing device associated with the specific account data entry 208. In an even further embodiment, the request to proceed may include at least the reward balance included in the specific account data entry 208 and may be transmitted via at least one of: short message service message, multimedia message service message, e-mail, and transmission to a point-of-sale device associated with the payment transaction.

### Computer System Architecture

FIG. 6 illustrates a computer system 600 in which embodiments of the present disclosure, or portions thereof, may be implemented as computer-readable code. For example, the processing server 110 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive, the removable storage unit 618 may be a floppy disk. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for initiating a rebate for a payment transaction funded using a reward account. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for initiating a rebate for a payment transaction funded using a reward account, comprising:
storing, in a database, a plurality of account data entries, wherein each account data entry includes data related to a consumer reward account including at least an account identifier and a reward balance;
receiving, by a receiving device, an authorization request for a payment transaction involving a merchant, wherein the authorization request includes at least payment information and a transaction amount;
calculating, by a processing device, a transaction reward value based on at least the transaction amount and at least one conversion rule;
identifying, by the processing device, a reduction amount, wherein the reduction amount is a lesser of the transaction reward value and the reward balance included in a specific account data entry in the database where the included account identifier corresponds to the payment information;
updating, in the database, the reward balance included in the specific account data entry based on the identified reduction amount;
calculating, by the processing device, a rebate amount based on the transaction reward value and the identified reduction amount, and the at least one conversion rule; and
transmitting, by a transmitting device, a rebate request for the calculated rebate amount from a payment account associated with the merchant to a payment account corresponding to the payment information.

2. The method of claim 1, further comprising:
transmitting, by the transmitting device, a notification to a consumer associated with the specific account data entry indicating successful transmission of the rebate request.

3. The method of claim 1, wherein each account data entry further includes an indication of whether the corresponding reward balance is to be used if the reward balance is less than the calculated transaction reward value.

4. The method of claim 1, wherein the at least one conversion rule is associated with at least one of: the merchant, the transaction amount, an account level, and a merchant category.

5. The method of claim 1, wherein, when the reward balance is less than the transaction reward value, the method further comprises:
receiving, by the receiving device, an indication to proceed with transmitting the rebate request prior to the transmitting of the rebate request.

6. The method of claim 5, wherein the indication to proceed is received in response to transmitting, by the transmitting device, a request to proceed to a computing device associated with the specific account data entry.

7. The method of claim 6, wherein the request to proceed includes at least the reward balance included in the specific account data entry and is transmitted via at least one of: short message service message, multimedia message service message, e-mail, and transmission to a reward-of-sale device associated with the payment transaction.

8. The method of claim 1, wherein the payment information includes the account identifier included in the specific account data entry.

9. The method of claim 1, wherein the rebate request is transmitted to a payment network.

10. The method of claim 1, further comprising:
receiving, by the receiving device, an indication of successful processing of a rebate in response to the transmitted rebate request; and
transmitting, by the transmitting device, a notification to a consumer associated with the specific account data entry indicating the successful processing of the rebate.

11. A system for initiating a rebate for a payment transaction funded using a reward account, comprising:
a database configured to store a plurality of account data entries, wherein each account data entry includes data related to a consumer reward account including at least an account identifier and a reward balance;
a receiving device configured to receive an authorization request for a payment transaction involving a merchant, wherein the authorization request includes at least payment information and a transaction amount;
a processing device configured to
calculate a transaction reward value based on at least the transaction amount and at least one conversion rule,
identify a reduction amount, wherein the reduction amount is a lesser of the transaction reward value and the reward balance included in a specific account data entry in the database where the included account identifier corresponds to the payment information,
update, in the database, the reward balance included in the specific account data entry based on the identified reduction amount, and
calculate a rebate amount based on the transaction reward value and the identified reduction amount, and the at least one conversion rule; and
a transmitting device configured to transmit a rebate request for the calculated rebate amount from a payment account associated with the merchant to a payment account corresponding to the payment information.

12. The system of claim 11, wherein the transmitting device is further configured to a notification to a consumer associated with the specific account data entry indicating successful transmission of the rebate request.

13. The system of claim 11, wherein each account data entry further includes an indication of whether the corresponding reward balance is to be used if the reward balance is less than the calculated transaction reward value.

14. The system of claim 11, wherein the at least one conversion rule is associated with at least one of: the merchant, the transaction amount, an account level, and a merchant category.

15. The system of claim 11, wherein the receiving device is further configured to, when the reward balance is less than the transaction reward value, receive an indication to proceed with transmitting the rebate request prior to the transmitting of the rebate request.

16. The system of claim 15, wherein the indication to proceed is received in response to transmitting, by the transmitting device, a request to proceed to a computing device associated with the specific account data entry.

17. The system of claim 16, wherein the request to proceed includes at least the reward balance included in the specific account data entry and is transmitted via at least one of: short message service message, multimedia message service message, e-mail, and transmission to a reward-of-sale device associated with the payment transaction.

18. The system of claim 11, wherein the payment information includes the account identifier included in the specific account data entry.

19. The system of claim 11, wherein the rebate request is transmitted to a payment network.

20. The system of claim 11, wherein
the receiving device is further configured to receive an indication of successful processing of a rebate in response to the transmitted rebate request, and
the transmitting device is further configured to transmit a notification to a consumer associated with the specific account data entry indicating the successful processing of the rebate.
